(19) United States
(12) Patent Application Publication
(10) Pub. No.: US 2026/0236891 A1
(43) Pub. Date: Aug. 13, 2026

(54) UNIFIED ARCHITECTURE FOR ARTIFICIAL INTELLIGENCE (AI) GENERATION OF MULTIMODAL CONTENT IN A PRODUCTIVITY SUITE

(71) Applicant: Google LLC, Mountain View, CA (US)

(72) Inventors: Gregory George Galante, Little Silver, NJ (US); Andrew James Motika, Birmingham, MI (US); Behnoosh Hariri, New York, NY (US); William Joshua Billingham, Brooklyn, NY (US); Heyang Wei, Astoria, NY (US); Matthew Robert Hughes, Brooklyn, NY (US); Merwan Vishnu Hade, San Carlos, CA (US); Nicholas Joseph Pesce, Brooklyn, NY (US); Sunny Yelu Tian, New York, NY (US); Weihao Lin, New York, NY (US); Fenil B. Shah, Huntington Station, NY (US)

(21) Appl. No.: 19/052,051

(22) Filed: Feb. 12, 2025

(51) Int. Cl. G06Q 10/109

(52) U.S. Cl. CPC G06Q 10/109

(57) ABSTRACT

Methods for generating high fidelity multi-modal content using a unified AI architecture are provided. A textual prompt including a request to generate content is received via a user interface (UI) of a productivity application. The textual prompt is provided to a first artificial intelligence (AI) model trained to determine that the content is to include content items of different content types, identify AI models to generate each content item, provide the textual prompt as input to the AI models, obtain the content items in an abstract format as outputs of the AI models, and combine the content items to produce the content. Upon obtaining one or more outputs of the first AI model, including the content in the abstract format, the content is converted into a format compatible with the productivity application and provided for presentation on a client device via the UI of the productivity application.

### TECHNICAL FIELD

Aspects and implementations of the present disclosure relate to methods for generating multi-modal content with a unified artificial intelligence (AI) architecture.

### BACKGROUND

The development and deployment of artificial intelligence (e.g., large language models (LLMs)) systems have revolutionized various industries by enabling the generation of content. Generating multi-modal content, or content including content items of different content types (e.g., images and text), can involve using multiple generative artificial intelligence (AI) models each trained to generate content items of one content type and rescaling and reformatting the generated content items of different content types into a single file, a process that uses large amounts of computing resources (e.g., processing power) and may not generate cohesive content items.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes receiving, via a user interface (UI) of a productivity application, a textual prompt including a request to generate content. The method further includes providing the textual prompt as input to a first artificial intelligence (AI) model. The first AI model is trained to determine that the content is to include a first content item of a first content type and a second content item of a second content type and identify a second AI model trained to generate content items of the first content type and a third AI mode trained to generate content items of the second content type. The first AI model is further trained to provide the textual prompt as input to the second AI model and the third AI model, obtain, as output of the second AI model, the first content item in an abstract format supporting multiple content types, and obtain, as output of the third AI model, the second content item in the abstract format. The first AI model is further trained to combine the first content item and the second content item to produce the content in the abstract format. The method further includes obtaining one or more outputs of the AI model. The one or more outputs include the content in the abstract format. The method further includes converting the content into a format compatible with the productivity application. The method further includes providing, for presentation on a client device via the UI of the productivity application, the content including the first content item and the second content item in the format compatible with the productivity application

In some implementations, the textual prompt identifies supplementary content to be used for generating the requested content. The produced content includes at least a portion of the supplementary content in the abstract format.

In some implementations, the method further includes converting the supplementary content into the abstract format. The method further includes providing the supplementary content in the abstract format as additional input to the first AI model.

In some implementations, the supplementary content is provided by one of a set of sources.

In some implementations, the set of sources includes a digital content platform, a local file directory or a network-based storage system.

In some implementations, the first AI model generates an outline for the content corresponding to the textual prompt.

In some implementations, the textual prompt is a natural language query.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2A depicts a flow diagram of an example method for generating multi-modal content using a unified AI architecture.

FIG. 2B depicts a flow diagram of an example sub-method for generating multi-modal content using unified AI architecture.

FIG. 3 is a block diagram illustrating an exemplary computer system, in accordance with implementations of the present disclosure.

### DETAILED DESCRIPTION

Aspects of the present disclosure relate to generating high fidelity multi-modal content using a unified artificial intelligence (AI) architecture. A user of a productivity application (e.g., an electronic mailing application, an electronic document processing application, etc.) can generate a content item of a content type (e.g., text, image, video, audio, etc.) using an AI chat program or content generation application. However, editing or using the generated content item may include manually importing the content item to a content editing program or productivity application. As such, creating multi-modal content, or content including content items of different content types, on a single productivity application may involve a lengthy multi-step process of switching between different productivity applications and content generation applications to export and reformat content items of different content types.

Some platforms include systems that generate multi-modal content, so users can generate content including content items of different content types without switching between different productivity applications and manually combining the generated content. However, contents of different content types convey information in different ways (e.g., images through pixels, text through words, etc.), making them difficult to combine in a cohesive and meaningful manner because content of each content type is generated independently by a separate AI model. The lack of cohesion is further exacerbated by AI models that are trained on separate datasets of one content type (e.g., one dataset of images, one dataset of text, etc.), which limits the ability of the generative AI models to understand the relationship between different content types and generate more cohesive content items. Additionally, contents of different content types are stored in different formats (e.g., plain text, pixel data, etc.) with unique data structures that are difficult to combine in a single file without reformatting and rescaling the content items, which can use significant computational resources (e.g., processing power, training data, etc.) to generate high fidelity multi-modal content. As such, current systems struggle to generate cohesive content and may use large amounts of computing resources.

Embodiments of the present disclosure address the above and other deficiencies by providing a method for generating high-fidelity multi-modal content using a unified AI architecture. As described herein, the system can receive a textual prompt that includes a request to generate multi-modal content via the user interface (UI) of a productivity application. The system can provide the textual prompt as an input to a first AI model trained to determine a set of content items of different content types for the requested multi-modal content, identify an AI model capable of generating each content item, and provide the textual prompt as input to the identified AI models. The first AI model can then obtain the outputs of the identified AI models, which include the generated content items in an abstract format (e.g., a structure capable of representing different content types in a standardized way). The first AI model can combine the generated content items in the abstract format into a single file to generate the requested multi-modal content in the abstract format. The system can receive one or more outputs of the first AI model, including the generated multi-modal content, and convert the multi-modal content to a format that is compatible with the productivity application. After the conversion, the system can provide the multi-modal content for presentation on a client device through the UI of the productivity application.

Aspects of the present disclosure provide techniques for generating high fidelity multi-modal content using a unified AI architecture that utilizes an abstract format to combine different types of generated content items and transfer the generated multi-modal content across different productivity applications in a productivity suite. The abstract format allows AI models to be trained using datasets including content items of more than one content type, expanding the ability of the AI models to understand the relationship between different content types and generate more cohesive content. For example, an image generation model can be trained on datasets of text and images in the abstract format, which allows it to generate images that better align with the text content of a document, increasing the coherence of the complete document. Additionally, by using an abstract format to represent generated content, processing logic and AI models can perform common operations such as transferring and combining content items in the same manner regardless of the content type, allowing the system to generate complex multi-modal content because the content items can be more easily combined. The abstract format also reduces time and computational resources (e.g., processing power, memory) spent for reformatting and rescaling content items to prevent inaccuracies when combining content items of different content types because content items can be treated in the same manner regardless of content type. Such computing resources can be made available for other processes, which increases the overall efficiency and decreases the overall latency of the system.

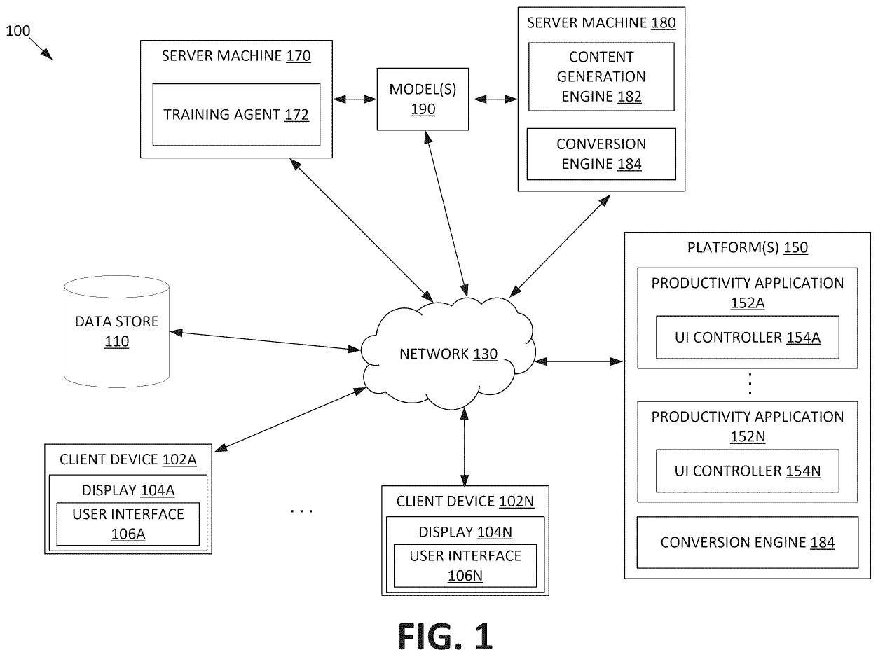

FIG. 1 illustrates an example system architecture 100, in accordance with implementations of the present disclosure. The system architecture 100 (also referred to as “system” herein) includes one or more client devices 102A-N, a data store 110, a platform 150 (e.g., a productivity suite), and/or one or more server machines (e.g., server machine 170 and server machine 180), each connected to a network 130. In implementations, network 130 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data can include (or include data of) one or more electronic documents and/or metadata associated with the one or more electronic documents, in accordance with embodiments described herein. Data store 110 can be hosted by one or more storage devices, such as main memory, magnetic or optical storage based disks, tapes or hard drives, NAS, SAN, and so forth.

Client devices 102A-N (collectively and individually referred to as client device(s) 102 herein) can include one or more computing devices such as personal computers (PCs), laptops, mobile phones, smart phones, tablet computers, netbook computers, network-connected televisions, etc. Client devices 102 can include a content viewer. In some implementations, a content viewer can be an application that provides a user interface (UI) 106 for users to view or upload content, such as images, media items, web pages, documents, etc, via a display 104.

In some implementations, platform 150 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with a file (e.g., an electronic document, an e-mail message, etc.) through productivity application 152. A productivity application 152 can be a software tool hosted on the platform 150 that allows users to access files stored by the platform 150 and perform specific tasks related to productivity (e.g., writing, data analysis, communication, organization). For example, productivity application 152 can be an electronic document processing application that may allow a user to create, edit (e.g., collaboratively with other users), access, or share with other users an electronic document stored at data store 110. The productivity application 152 can include a UI controller 154 that manages interactions between the UI and application logic, such as handling user interactions with the UI (e.g., processing an input when a user presses a button) and dynamically updating the UI to reflect the state of the application (e.g., updating the UI to present a requested document).

As illustrated in FIG. 1, system 100 can include a content generation engine 182 hosted by server 180. Content generation engine 182 can receive a textual prompt including a request to generate multi-modal content, or content that includes multiple content types (e.g., text, images, video, audio, etc.), from a productivity application 152 and provide the textual prompt (e.g., user input) as input to a first AI model (e.g., model 190) trained to generate multi-modal content by determining multiple content types to be included in the multi-modal content, identifying and calling one or more additional AI models (e.g., AI models 190) to generate content items of each determined content type in an abstract format (e.g., a generalized structure capable of representing different content types in a standardized way), and combining the generated content items in a single file in the abstract format.

Content generation engine 182 can obtain the multi-modal content in the abstract format from the first AI model 190 and provide the multi-modal content to a conversion engine 184, which converts the multi-modal content from the abstract format to a format that is compatible with a productivity application 152. For example, conversion engine 184 can convert text with images in the abstract format into a format that is compatible with an electronic document application. The content generation engine 182 can provide the multi-modal content with the compatible format to a productivity application 152. The UI controller 154 can update the UI 106 provided to the client device 102 to include the generated multi-modal content for presentation to a user.

In some embodiments, the AI model 190 may be one or more generative AI models, allowing for the generation of new and original content. Depending on the embodiment, the AI model 190 can be an AI model that has been trained on a corpus of data including content items of different content types (e.g., text, images, audio, etc.) by a training agent 172 on server machine 170. In some embodiments, the training agent 172 can pre-train the AI model 190 on a corpus of content items of different content types to create a foundational model, and afterwards fine-tune the AI model 190 on more data pertaining to a particular set of tasks to create a more task-specific, or targeted, model. The training agent 172 can pre-train the foundational model using a corpus of content items of different content types that can include content in the public domain, licensed content, and/or proprietary content. In some embodiments, this first, foundational model can be trained using self-supervision, or unsupervised training on such datasets.

In some embodiments, an AI model, such as model 190, may be (or may correspond to) one or more computer programs executed by processor(s) of server machine 170 and/or server machine 180. In other embodiments, an AI model may be (or may correspond to) one or more computer programs executed across a number or combination of server machines. In some embodiments, the AI models may be a self-hosted AI model, while in other embodiments, AI models may be external AI models accessed by an application programming interface (API).

It should be noted that although FIG. 1 illustrates content generation engine 184 and conversion engine 184 as part of server machine 180, in additional or alternative embodiments, one or more portions or components of content generation engine 184 and/or conversion engine 184 can reside and/or be executed at client device(s) 102, or platform 150.

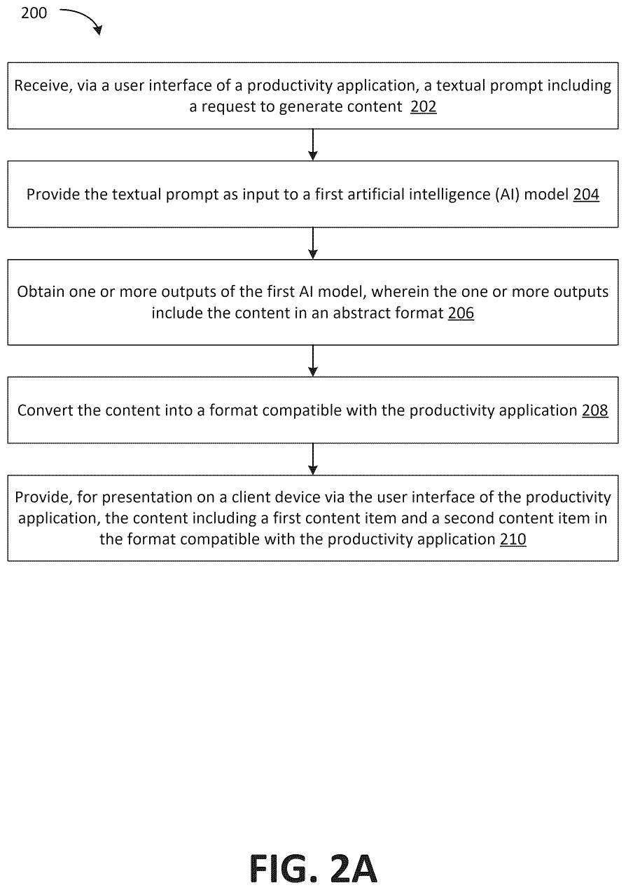

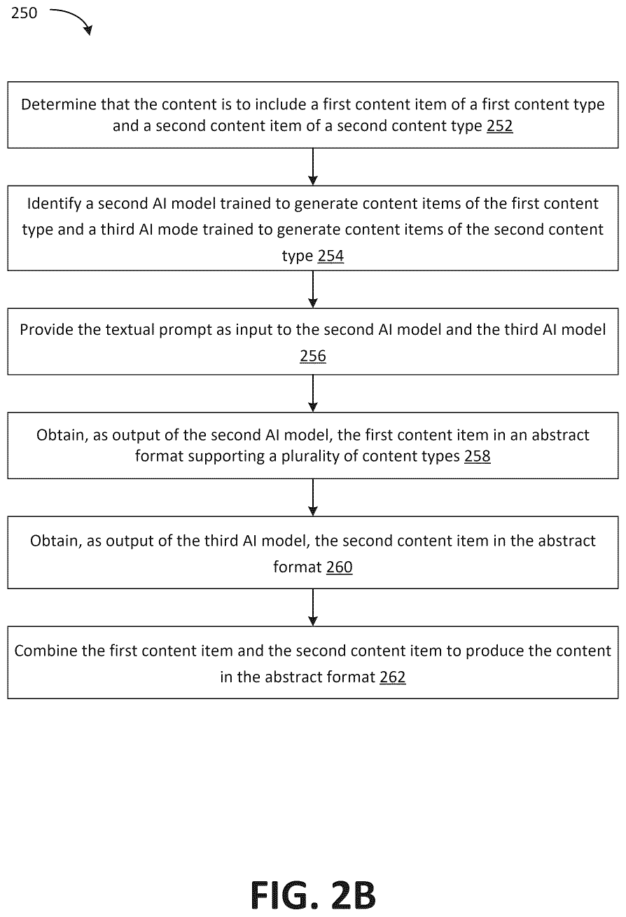

FIG. 2A depicts a flow diagram of an example method for generating multi-modal content with a unified AI architecture. Method 200 can be performed by processing logic that can include hardware (e.g., circuitry, dedicated logic, etc.), software (e.g., instructions run on a processing device), or a combination thereof. In one implementation, some or all the operations of method 200 can be performed by one or more components of system 100 of FIG. 1. In some embodiments, some or all of the operations of method 200 can be performed by content generation engine 182 and/or conversion engine 184.

At block 202, processing logic (e.g., the content generation engine 182) receives, via a UI of a productivity application (e.g., productivity application 152) a textual prompt. In some embodiments, a first-or third-party tool can interact with the productivity application to provide the textual prompt through an API. In some embodiments, the textual prompt can be a natural language query. The textual prompt includes a request to generate multi-modal content for presentation on the productivity application. For example, a user can engage with one or more UI elements (e.g., typing in a text box), via the UI 106 of the client device 102, to provide a request to generate multi-modal content. Upon detecting the user interaction with the one or more UI elements, the UI controller 154 can provide the textual prompt to the productivity application 152, which provides the textual prompt to the content generation engine 182. In some embodiments, the UI controller 154 can provide the textual input directly to the content generation engine 182.

In some embodiments, the textual prompt can identify supplementary content to be used when generating the multi-modal content. For example, the textual prompt can include a link to a document that is to be used when generating the multi-modal content. Depending on the embodiment, the supplementary content can include content hosted on a digital content platform (e.g., platform 150), a local file directory, or a network-based storage system (e.g., data store 110). The processing logic can retrieve the supplementary content and convert the supplementary content to an abstract format (e.g., using conversion engine 184). For example, a textual prompt can request the generation of a document with images that incorporates information (e.g., text) from a separate document stored on data store 110. The content generation engine 182 can identify the separate document, retrieve it from data store 110, and convert the separate document to the abstract format using conversion engine 184.

Depending on the embodiment, the processing logic can comply with privacy requirements and access limitations when accessing the supplementary content. In some embodiments, the processing logic can use an access control list that specifies users and systems with access to requested webpages and/or files to determine whether the requesting user has access to the supplementary content. An access control list can be stored in data store 110, in some embodiments. If the identified supplementary content is unavailable or cannot be accessed, the processing logic can transmit an alert to the user, in some embodiments.

At block 204, processing logic provides the textual prompt as input to a first AI model (e.g., model 190) trained to generate multi-modal content in an abstract format based a textual prompt. An abstract format is a generalized structure used for the transport and storage of content items that can represent different content types in a standardized way, which makes storing and combining content items of different content items more efficient because the content items can be treated in a uniform way regardless of the content type. In embodiments where the textual prompt identifies supplementary content, the processing logic can provide the supplementary content in the abstract format as an additional input to the first AI model.

At block 206, processing logic obtains one or more outputs of the first AI model. The one or more outputs include the multi-modal content in an abstract format. In some embodiments, the content generation engine 182 can extract the multi-modal content from the one or more outputs of the first AI model. Additional details regarding some implementations of generating, using the first AI model, the one or more outputs including the content in an abstract format are described below with reference to FIG. 2B

At block 208, processing logic converts the multi-modal content into a format compatible with the productivity application (e.g., productivity application 152). For example, content generation engine 182 can provide the multi-modal content to the conversion engine 184, which converts the multi-modal content into an electronic document format that is compatible with an electronic document application. Such formats can include word processing formats, presentation formats, email messaging formats, spreadsheet formats, and electronic mail formats.

At block 210, processing logic provides, for presentation on a client device (e.g., client device 102) via the UI of the productivity application, the multi-modal content. Upon receiving the multi-modal content, the UI controller 154 can update the UI 106 associated with the productivity application 152 on the client device 102. In embodiments where the productivity application is accessed through an API, the processing logic can provide the multi-modal content to the API request source.

FIG. 2B depicts a flow diagram of an example sub-method for generating the muti-modal content in the abstract format using the first AI model (e.g., model 190). Method 250 can be performed by processing logic that can include hardware (circuitry, dedicated logic, etc.), software (e.g., instructions run on a processing device), or a combination thereof. In one implementation, some or all the operations of method 250 can be performed by one or more components of system 100 of FIG. 1.

At block 252, processing logic determines that the multi-modal content is to include a first content item of a first content type and a second content item of a second content type. The first AI model can receive the textual prompt as input from the processing logic, as described in block 204, and use the textual prompt to determine a set of content items to be included in the requested multi-modal content. In some embodiments, the first AI model can include an intent detection system to deconstruct the textual prompt, identify the set of content items, and generate a set of operations to perform to generate the document. Deconstruction of the textual prompt can include tokenization to split the request into smaller units (e.g., words or characters), contextual encoding to process the smaller units (e.g., by assigning a numerical representation to a unit based on the context provided by surrounding smaller units), intent understanding to analyze patterns in the textual input (e.g., identifying action words, question types, etc.), and/or context matching to evaluate the context of the request against training data. By deconstructing the textual prompt, the first AI model can determine a set of content items of different content types to be included in the multi-modal content. The determined set of operations can include generating document metadata (e.g., the format type, title, etc.) based on the requested format of the multi-modal content (e.g., document, presentation, etc.), generating text, generating structural elements (e.g., title, table of contents, margins, text and non-text styling, etc.), generating media content (e.g., images, video, audio, charts, diagrams, etc.), and identifying media content from common libraries. For example, a textual prompt can include a request to generate a document with text and images. The first AI model can deconstruct the textual prompt and identify a first content item including text and a second content item including images. Based on this determination, the first AI model can determine operations to generate the document, including generating the text and generating the images.

In some embodiments the first AI model can generate an outline for the content corresponding to the textual prompt. After receiving the textual prompt, the first AI model can deconstruct the prompt to determine the type of multi-modal content that is requested. The first AI model can identify features including the context (e.g., the subject matter), the goal (e.g., the desired outcome to persuade, inform, etc.), and/or scope (e.g., length, specificity, etc.) of the requested multi-modal content and use pre trained knowledge (e.g., from the training agent 172), to identify structural patterns of similar documents. The first AI model can use the structural patterns to generate an outline of the requested multi-modal content based on the textual prompt. For example, the first AI model can determine that a textual prompt requests a report and determine that reports often consist of a title page, abstract, table of contents, introduction, discussion of findings, and conclusion. Based on the identified pattern, the first AI model can create an outline for the requested report with a similar structure.

At block 254, processing logic identifies a second AI model trained to generate content items of the first content type and a third AI model trained to generate content items of the second content type. In some embodiments, the first AI model can identify the second and third AI models by identifying AI models that are trained to perform an operation of the set operations to generate the multi-modal content. For example, the first AI model can identify a text generation model based on an operation to generate text for the multi-modal content. In some embodiments, AI models 190 includes the second and third AI models. Depending on the embodiment, the second and third AI models can be trained by training agent 172 to generate a specific type of content.

At block 256, processing logic provides the textual prompt as input to the second AI model and the third AI model. In embodiments that identify supplementary content, the first AI model can provide the supplementary content in the abstract format as input to the second or third AI model in addition to the textual prompt. Depending on the embodiment, the first AI model may deconstruct the supplementary content (e.g., to extract text, summarize the content, analyze the writing style, etc.) and provide the deconstructed information (e.g., extracted text, summary of content, etc.) to the second and third model.

At block 258, processing logic obtains, as output of the second AI model, the first content item in an abstract format. At block 260, processing logic obtains, as output of the third AI model, the second content item in the abstract format. Depending on the embodiment, the first AI model can extract the first content item from one or more outputs of the second AI model and extract the second content item from one or more outputs of the third AI model.

At block 262, processing logic combines the first content item and the second content item to produce the multi-modal content in the abstract format. The first AI model can combine the content items by placing the generated content items at relevant points in a single file and formatting the content items (e.g., aligning text and images). In some embodiments, the first AI model can use the generated outline to structure the content items within the file, by determining where to insert content items based on the relevance of a content item to a structural component. For example, the first AI model can place a detailed graph or chart of test results in the body of the file with text that provides a thorough description of test results. The first AI model then generates one or more outputs, including the multi-modal content, which is obtained by the processing logic (e.g., content generation engine) at block 206.

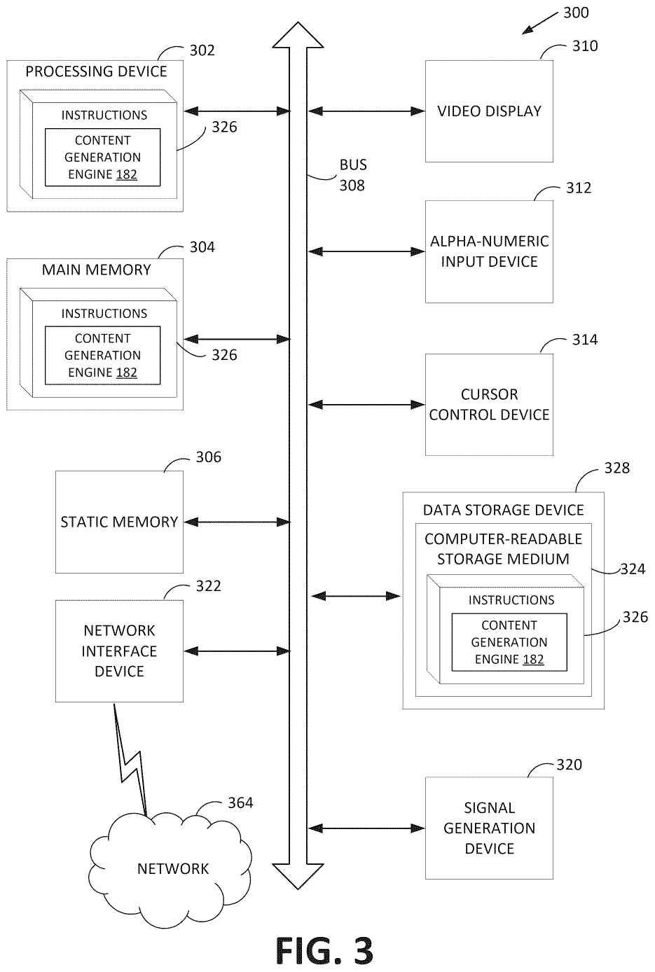

FIG. 3 is a block diagram illustrating an exemplary computer system 300, in accordance with implementations of the present disclosure. The computer system 300 can correspond to platform(s) 150, client devices 102A-N, server machine 170, and/or server machine 180 described herein and with respect to FIGS. 1-2B. Computer system 300 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processing device (processor) 302, a main memory 304 (e.g., read-only memory (ROM), flash memory, dynamic random access memory (DRAM) such as synchronous DRAM (SDRAM), double data rate (DDR SDRAM), or DRAM (RDRAM), etc.), a static memory 306 (e.g., flash memory, static random access memory (SRAM), etc.), and a data storage device 328, which communicate with each other via a bus 308.

Processor (processing device) 302 represents one or more general-purpose processing devices such as a microprocessor, central processing unit, or the like. More particularly, the processor 302 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 302 can also be one or more special-purpose processing devices such as an application specific integrated circuit (ASIC), a field programmable gate array (FPGA), a digital signal processor (DSP), network processor, or the like. The processor 302 is configured to execute instructions 326 and the content generation engine 182 for performing the operations discussed herein.

The computer system 300 can further include a network interface device 322. The computer system 300 also can include a video display unit 310 (e.g., a liquid crystal display (LCD) or a cathode ray tube (CRT)), an input device 312 (e.g., a keyboard, and alphanumeric keyboard, a motion sensing input device, touch screen), a cursor control device 314 (e.g., a mouse), and a signal generation device 320 (e.g., a speaker).

The data storage device 328 can include a non-transitory machine-readable storage medium 324 (also computer-readable storage medium) on which is stored one or more sets of instructions 326 embodying any one or more of the methodologies or functions described herein. The instructions can also reside, completely or at least partially, within the main memory 304 and/or within the processor 302 during execution thereof by the computer system 300, the main memory 304 and the processor 302 also constituting machine-readable storage media. The instructions can further be transmitted or received over a network 364 via the network interface device 322.

In one implementation, the instructions 326 include instructions for providing fine-grained version histories of electronic documents at a platform. While the computer-readable storage medium 324 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, via a user interface of a productivity application, a textual prompt comprising a request to generate content;
providing the textual prompt as input to a first artificial intelligence (AI) model, wherein the first AI model is trained to:
determine that the content is to include a first content item of a first content type and a second content item of a second content type;
identify a second AI model trained to generate content items of the first content type and a third AI mode trained to generate content items of the second content type;
provide the textual prompt as input to the second AI model and the third AI model;
obtain, as output of the second AI model, the first content item in an abstract format supporting a plurality of content types;
obtain, as output of the third AI model, the second content item in the abstract format; and
combine the first content item and the second content item to produce the content in the abstract format;
obtaining one or more outputs of the first AI model, wherein the one or more outputs comprise the content in the abstract format;
converting the content into a format compatible with the productivity application; and
providing, for presentation on a client device via the user interface of the productivity application, the content comprising the first content item and the second content item in the format compatible with the productivity application.

2. The method of claim 1, wherein the textual prompt identifies supplementary content to be used for generating the requested content, and wherein the produced content comprises at least a portion of the supplementary content in the abstract format.

3. The method of claim 2, further comprising:
converting the supplementary content into the abstract format; and
providing the supplementary content in the abstract format as additional input to the first AI model.

4. The method of claim 2, wherein the supplementary content is provided by one of a plurality of sources.

5. The method of claim 4, wherein the plurality of sources comprises a digital content platform, a local file directory or a network-based storage system.

6. The method of claim 1, wherein the first AI model generates an outline for the content corresponding to the textual prompt.

7. The method of claim 1, wherein the textual prompt is a natural language query.
